(19) United States
(12) Patent Application Publication
(10) Pub. No.: US 2011/0110516 A1
(43) Pub. Date: May 12, 2011

(54) CONTENT RECEIVER, CONTENT REPRODUCER, MANAGEMENT SERVER, CONTENT USE SYSTEM, CONTENT USE METHOD, METHOD OF WRITE-OUT FROM CONTENT RECEIVER, METHOD OF POSSIBLE VIEWING TIME MANAGEMENT ON CONTENT REPRODUCER, METHOD OF TIME LIMIT FIXATION IN MANAGEMENT SERVER, AND PROGRAM

(76) Inventor: Kensuke SATOH, Osaka (JP)

(21) Appl. No.: 12/848,504

(22) Filed: Aug. 2, 2010

(30) Foreign Application Priority Data
Nov. 6, 2009 (JP) 2009-254658

(51) Int. Cl. H04N 7/167; G06F 21/24

(52) U.S. Cl. 380/201; 726/26

(57) ABSTRACT

In a service enabling viewing of a rental content time-limit-managed by a copyright protection system (DRM) for a certain time period from first-time viewing in a video download service through a network, even possible viewing times for the content under the one and another copyright protection systems when the content is exported to a removable medium in conformity with the other system (CPS) before first-time viewing under DRM management are synchronized. When a content time-limit-managed by a copyright protection system is exported to a removable recording medium in conformity with a different content protection system, a URL for a management server is designated and a request is made of the designated management server to fix a possible viewing time if the URL of the management server is designated when the content is viewed for the first time in a content reproducer in conformity with the content protection system.

### FIELD OF THE INVENTION

The present invention relates to a content receiver, a content reproducer, a management server, a content use system, a content use method, a method of write-out from the content receiver, a method of possible viewing time management on the content reproducer and a method of time limit fixation in the management server enabling use of a content recorded on a removable recording medium according to a copyright on the content.

### BACKGROUND OF THE INVENTION

Download services using a system in which a video content is downloaded from a content server into a storage medium such as a hard disk in a content receiver by using a network and is thereafter viewed or listened to with the content receiver have been established in recent years and are now becoming widespread. Forms of such service include a sellout-type form of service enabling perpetual viewing/listening of a video content after purchase of the video content and a rental-type form of service enabling viewing/listening of a video content in a certain period of time after purchase of the video content. In either of these forms of service, a content receiver uses a copyright protection system (Digital Rights Management: DRM) for management of content use conditions. In particular, on rental contents, possible viewing time management according to the DRM is performed.

In typical download-type rental selling, a content business who supplies contents operates a content server and a DRM server, and a content receiver on the viewer side receives an encrypted rental content downloaded from the content server and obtains a key for decryption of the encrypted content and conditions for viewing of the content from the DRM server. The conditions for content viewing include information on the period of time during which the content can be viewed and a condition for copying of the content.

Several methods of setting a viewable period in a rental service are conceivable. A form of service is assumed to enable setting of a viewable period with respect to a video content for convenience of a user who views the video content such that the beginning of the viewable period is not a point in time at which the user purchases the content but a point in time at which the user first views the video content (first viewing time). In such a form of service, only a time period (e.g., 72 hours) in which a content can be viewed is prescribed when the content is purchased by a user, and an expiration time limit before which the content can be viewed (e.g., 13 o'clock August 7) is fixed only when the user first views the content.

Also, a form of service is assumed to enable not only viewing with a content receiver of a video content downloaded to a hard disk but also writing a copy of the downloaded video content out of the content receiver to a removable medium such as a memory card and viewing of the copy of the downloaded video content with a portable terminal or the like.

Patent Document 1 (Japanese Patent Laid-Open No. 2002-202917) discloses, as a technique to control reproduction of a time-limited content in a portable terminal or the like, a technique including writing to a recording medium such as a removable disk information on a recording date/time at which a content is written to the recording medium simultaneously with writing the content to the recording medium, comparing the recording time and a reproducing time at which the content is reproduced through a portable terminal and the recording time, and permitting reproduction of the content if the difference between the recording time and the reproducing time is equal to or shorter than a predetermined length of time.

Even when a content for which no expiration time limit (viewable time limit) is fixed before a user views the content is written to a removable medium in the above-described form of rental service in which the beginning of a viewable period is a first viewing time, the technique disclosed in Patent Document 1 enables controlling an expiration time limit before which the content is available so that the content can be reproduced only in a predetermined time period from the point in time at which the content is written to the removable medium.

All the disclosures of the Patent Document 1 are cited in its entirety and thereby become an integral part hereof.

However, the above-described conventional technique is incapable of synchronizing an expiration time limit for a content in a hard disk in a content receiver and an expiration time limit for the same content in a removable medium with each other. Also in a case where a content is written to a plurality of removable media, the technique is incapable of synchronizing expiration time limits for the contents in the removable media with each other.

That is, in a case where a copy of a video content is written from a content receiver to a removable medium before the content is viewed with the content receiver for the first time, an expiration time limit is fixed for the content in the removable medium at the time of recording the content on the removable medium, while a time after a predetermined viewable period is set as an expiration time limit for the content in the content receiver when viewing of the content from the content receiver for the first time is started. Therefore these expiration time limits cannot be synchronized with each other. Also, in a case where a content is written to a plurality of removable media, the content is recorded at different times on the removable media and different expiration time limits are therefore set for the contents in the removable media.

Further, fixing an expiration time limit when a content recorded on a removable medium is first reproduced through a portable terminal instead of fixing an expiration time limit at the time of recording on the recording medium is also conceivable. Also in such a case, the times at reproducing each content in different removable media are different from each other, therefore expiration time limits for each content in different removable media are different from each other.

If different expiration time limits are set for copies of a content, a user can view the copy of the content with a later one of the expiration time limits for the corresponding longer time period, resulting in failure to satisfy the content provider's condition. There is, therefore, a need for synchronization of expiration time limits between a plurality of portable terminals and between a content receiver and other devices.

In general, systems for protecting contents (Content Protection System: CPS) proper to kinds of removable media are specified. At the time of writing to a removable medium, there is a need for handover (export) of a copyright protection system between systems for protecting contents from the DRM in a download service to a CPS for the removable medium.

In the case of the technique disclosed in the Patent Document 1, a portable terminal which reproduces a content in a removable medium protected by a CPS has no means for accessing a server using a different system for protecting contents, the DRM, and is, therefore, incapable of synchronizing, about expiration time limits, the content in the removable medium with the content in a hard disk in a content receiver managed by the DRM.

In view of the above-described conventional problems, an object of the present invention is to provide a content receiver, a content reproducer, a management server, a content use system, a content use method, a method of write-out from the content receiver, a method of possible viewing time management on the content reproducer and a method of time limit fixation in the management server enabling synchronization between an expiration time limit for a content under management of a system for protecting contents using a copyright protection system (e.g., the DRM), to which content only a viewable period is assigned by the copyright protection system without setting an expiration time limit, and an expiration time limit for the same content under a different system for protecting contents (e.g., a CPS) even in a case where the content is exported to the different system for protecting contents by designating only the viewable period.

### SUMMARY OF THE INVENTION

To solve the above-described problems,

The 1^{st} aspect of the present invention is a content receiver which receives from a content server a content for which a possible viewing time is managed by a copyright protection system, and which writes out the content to a removable recording medium managed by a content protection system, the content receiver comprising:

a recording section which, when writing the content out to the removable recording medium, records, on the removable recording medium, together with the content, management server reference information indicating a location of a management server which fixes the possible viewing time in place of a unit for fixing the possible viewing time provided in the content protection system.

The 2^{nd} aspect of the present invention is the content receiver according to the 1^{st} aspect of the present invention, wherein

the management server reference information is obtained by receiving a write-out license when the content is written out to the removable recording medium.

The 3^{rd} aspect of the present invention is the content receiver according to the 1^{st} aspect of the present invention, wherein

when writing the content out to the removable recording medium, if the possible viewing time is still unfixed, the recording section records information about the unfixed possible viewing time on the removable recording medium together with the content, or if the possible viewing time is already fixed, the recording section records the already fixed possible viewing time on the removable recording medium together with the content.

The 4^{th} aspect of the present invention is the content receiver according to the 1^{st} aspect of the present invention, wherein

the management server reference information is a URL of the management server that fixes the possible viewing time for the content and that is managed by the copyright protection system.

The 5^{th} aspect of the present invention is a content reproducer which reproduces a content, a possible viewing time of which is managed by a copyright protection system, received from a content server and recorded on the removable recording medium managed by a content protection system, the content reproducer comprising:

a possible viewing time obtaining section which, at a time of fixing the possible viewing time for the content that has an unfixed possible viewing time, if management server reference information indicating a location of a management server which fixes the possible viewing time is recorded on the removable recording medium, makes a request of the management server indicated by the management server reference information to fix the possible viewing time for the content without using a unit for fixing the possible viewing time provided in the content protection system.

The 6^{th} aspect of the present invention is the content reproducer according to the 5^{th} aspect of the present invention, wherein

if time limit synchronization management information for identifying the content as an object to be possible viewing time synchronized is recorded on the removable recording medium together with the content, the possible viewing time obtaining section transmits the time limit synchronization management information to the management server indicated by the management server reference information, when making the request to fix the possible viewing time.

The 7^{th} aspect of the present invention is a management server for managing a possible viewing time of a content for a content receiver which receives from a content server the content for which the possible viewing time is managed by a copyright protection system, and which writes out the content to a removable recording medium managed by a content protection system, and for a content reproducer which reproduces the content recorded on the removable recording medium, the management server comprising:

a possible viewing time supply section which, after receiving from the content reproducer a request to fix the possible viewing time,

(a) if the possible viewing time for the content is still unfixed, fixes the possible viewing time for the content with reference to a present time, records the fixed possible viewing time for the content, and supplies the content reproducer with the fixed possible viewing time as the possible viewing time for the content, and

(b) if the possible viewing time for the content is already fixed, supplies the content reproducer with the already fixed possible viewing time as the possible viewing time for the content,

wherein when the content receiver writes out the content to the removable recording medium, management server reference information indicating a location of the management server that fixes the possible viewing time is recorded on the removable recording medium together with the content, and

wherein if the management reference information is recorded on the removable recording medium when the content reproducer fixes the unfixed possible viewing time for the content, the request to fix the possible viewing time for the content is transmitted to the management server indicated by the management server reference information while a unit for fixing the possible viewing time provided in the content protection system is not used.

The 8^{th} aspect of the present invention is the management server according to the 7^{th} aspect of the present invention, wherein

upon receiving a reproduction license request from the content receiver, if the content receiver has a function to reproduce the content,

(a) the possible viewing time supply section fixes the possible viewing time for the content with reference to the present time if the possible viewing time for the content is still unfixed, records the fixed possible viewing time for the content, and supplies the content receiver with the fixed possible viewing time as the possible viewing time for the content, and

(b) if the possible viewing time for the content is already fixed, the possible viewing time supply section supplies the content receiver with the already fixed possible viewing time as the possible viewing time for the content.

The 9^{th} aspect of the present invention is a content use system comprising a content receiver which receives from a content server a content for which a possible viewing time is managed by a copyright protection system, and which writes out the content to a removable recording medium managed by a content protection system, a content reproducer which reproduces the content recorded on the removable recording medium, and a management server which manages the possible viewing time for the content,

the content receiver having a recording section which, when writing out the content to the removable recording medium, records, on the removable recording medium, together with the content, management server reference information indicating a location of the management server that fixes the possible viewing time,

the content reproducer having a possible viewing time obtaining section which, at the time of fixing the possible viewing time for the content that has an unfixed possible viewing time, if the management server reference information is recorded on the removable recording medium, makes a request of the management server indicated by the management server reference information to fix the possible viewing time for the content without using a unit for fixing the possible viewing time provided in the content protection system,

the management server having a possible viewing time supply section which, after receiving from the content reproducer the request to fix the possible viewing time for the content,

(a) fixes the possible viewing time for the content with reference to a present time if the possible viewing time for the content is still unfixed, records the fixed possible viewing time for the content, and supplies the content reproducer with the fixed possible viewing time as the possible viewing time for the content, and

(b) if the possible viewing time for the content is already fixed, supplies the content reproducer with the already fixed possible viewing time as the possible viewing time for the content.

The 10^{th} aspect of the present invention is a content use method for a content use system including a content receiver which receives from a content server a content for which a possible viewing time is managed by a copyright protection system, and which writes out the content to a removable recording medium managed by a content protection system, a content reproducer which reproduces the content recorded on the removable recording medium, and a management server which manages the possible viewing time for the content, the content use method comprising:

a recording step of recording, on the removable recording medium, together with the content, management server reference information indicating a location of the management server that fixes the possible viewing time, when the content receiver writes out the content to the removable recording medium;

a possible viewing time obtaining step of obtaining the possible viewing time by making, at the time of fixing the possible viewing time for the content that has an unfixed possible viewing time, a request of the management server indicated by the management server reference information to fix the possible viewing time for the content without using a unit for fixing the possible viewing time provided in the content protection system, if the management server reference information is recorded on the removable recording medium; and

a possible viewing time supplying step of supplying the possible viewing time for the content after the management server has received the request to fix the possible viewing time for the content from the content reproducer, including:

(a) fixing the possible viewing time for the content with reference to a present time if the possible viewing time for the content is still unfixed, recording the fixed possible viewing time for the content, and supplying the content reproducer with the fixed possible viewing time as the possible viewing time for the content; and

(b) supplying, if the possible viewing time for the content is already fixed, the content reproducer with the already fixed possible viewing time as the possible viewing time for the content.

The 11^{th} aspect of the present invention is the content use method according to the 10^{th} aspect of the present invention, wherein,

in the recording step, the management server reference information is obtained by receiving a write-out license from the management server when the content is written out to the removable recording medium;

the write-out license includes time limit synchronization management information for identifying the content as an object to be possible viewing time synchronized;

in the recording step, the time limit synchronization management information is also recorded when the content is recorded on the removable recording medium;

in the possible viewing time obtaining step, the time limit synchronization management information is transmitted to the management server when the request of the management server to fix the possible viewing time for the content is made; and

in the possible viewing time supplying step, it is determined whether the content requested to fix the possible viewing time is an object to be possible viewing time synchronized from the time limit synchronization management information received from the content receiver.

The 12^{th} aspect of the present invention is the content use method according to the 10^{th} aspect of the present invention, further comprising:

a encrypting step of encrypting the content by means of the content receiver and encrypting a decryption key for decrypting the content by an encryption system in accordance with the copyright protection system; and

a decrypting step of decrypting by means of the content reproducer the content recorded on the removable recording medium,

wherein in the recording step, the encrypted content, the encrypted decryption key and the management server reference information are recorded on the removable recording medium, and

wherein in the decrypting step, a decryption key for decrypting the decryption key for the content is inquired and obtained from the management server indicated by the server reference information at the time of use of the content in the reproducer, the decryption key for the content is decrypted by using the obtained decryption key, and the content is decrypted by using the decrypted decryption key for the content.

The 13^{th} aspect of the present invention is the content use method according to the 12^{th} aspect of the present invention, wherein

in the encrypting step, the decryption key for decrypting the content is generated by encrypting with values passed through a unidirectional function in the copyright protection system.

The 14^{th} aspect of the present invention is the content use method according to the 12^{th} aspect of the present invention, wherein

in the decrypting step, when the decryption key for the content is decrypted, the decryption key for the content is decrypted using the decryption key obtained from the management server and a unique ID for the removable recording medium.

The 15^{th} aspect of the present invention is the content use method according to the 12^{th} aspect of the present invention, wherein

in the possible viewing time obtaining step, the decryption key used for decrypting the decryption key for the content is supplied from the management server when the request to fix the possible viewing time for the content is made.

The 16^{th} aspect of the present invention a method of write-out from a content receiver which receives from a content server a content for which a possible viewing time is managed by a copyright protection system, and which writes out the content to a removable recording medium managed by a content protection system, the method comprising:

a recording step of recording, on the removable recording medium, together with the content, management server reference information indicating a location of a management server which fixes the possible viewing time in place of a unit for fixing the possible viewing time provided in the content protection system, when the content is written out to the removable recording medium.

The 17^{th} aspect of the present invention is a method of possible viewing time management on a content reproducer which reproduces a content, a possible viewing time of which is managed by a copyright protection system, received from a content server and recorded on the removable recording medium managed by a content protection system, the method comprising:

a possible viewing time obtaining step of obtaining the possible viewing time by making a request of a management server indicated by management server reference information to fix the possible viewing time for the content without using a unit for fixing the possible viewing time provided in the content protection system, if the management server reference information indicating a location of the management server that fixes the possible viewing time is recorded on the removable recording medium at the time of fixing the possible viewing time for the content that has an unfixed possible viewing time.

The 18^{th} aspect of the present invention is a method of time limit fixation in a management server for managing a viewing time limit of a content for a content receiver which receives from a content server the content for which a possible viewing time is managed by a copyright protection system, and which writes out the content to a removable recording medium managed by a content protection system, and for a content reproducer which reproduces the content recorded on the removable recording medium, the method comprising:

a possible viewing time supplying step of supplying the possible viewing time for the content after a request to fix the possible viewing time has been received from the content reproducer, including:

(1) fixing the possible viewing time for the content with reference to a present time if the possible viewing time for the content is still unfixed, recording the fixed possible viewing time for the content, and supplying the content reproducer with the fixed possible viewing time as the possible viewing time for the content; and

(2) supplying, if the possible viewing time for the content is already fixed, the content reproducer with the already fixed possible viewing time as the possible viewing time for the content,

wherein when the content receiver writes out the content to the removable recording medium, management server reference information indicating a location of the management server that fixes the possible viewing time is recorded on the removable recording medium together with the content, and

wherein if the management reference information is recorded on the removable recording medium when the content reproducer fixes the unfixed possible viewing time for the content, the request to fix the possible viewing time for the content is transmitted to the management server indicated by the management server reference information while a unit for fixing the possible viewing time provided in the content protection system is not used.

The 19^{th} aspect of the present invention is a program embodied on a non-transitory and tangible computer-readable medium, the program causing a computer to execute a method of write-out from a content receiver which receives from a content server a content for which a possible viewing time is managed by a copyright protection system, and which writes out the content to a removable recording medium managed by a content protection system, the method comprising a recording step of recording, on the removable recording medium, together with the content, management server reference information indicating a location of a management server which fixes the possible viewing time in place of a unit for fixing the possible viewing time provided in the content protection system, when the content is written out to the removable recording medium.

The 20^{th} aspect of the present invention is a program embodied on a non-transitory and tangible computer-readable medium, the program causing a computer to execute a method of possible viewing time management on a content reproducer which reproduces a content recorded on a removable recording medium, for which a possible viewing time is managed by a copyright protection system, which is received from a content server, and which is recorded on the removable recording medium managed by a content protection system, the method comprising a possible viewing time obtaining step of obtaining the possible viewing time by making a request of a management server indicated by management server reference information to fix the possible viewing time for the content without using a unit for fixing the possible viewing time provided in the content protection system, if the management server reference information indicating a location of the management server that fixes the possible viewing time is recorded on the removable recording medium at the time of fixing the possible viewing time for the content that has an unfixed possible viewing time.

The 21^{st} aspect of the present invention is a program embodied on a non-transitory and tangible computer-readable medium, the program causing a computer to execute a method of time limit fixation in a management server for managing a viewing time limit of a content for a content receiver which receives from a content server the content for which a possible viewing time is managed by a copyright protection system, and which writes out the content to a removable recording medium managed by a content protection system, and for a content reproducer which reproduces the content recorded on the removable recording medium, the method comprising:

a possible viewing time supplying step of supplying the possible viewing time for the content after a request to fix the possible viewing time has been received from the content reproducer, including:

(1) fixing the possible viewing time for the content with reference to a present time if the possible viewing time for the content is still unfixed, recording the fixed possible viewing time for the content, and supplying the content reproducer with the fixed possible viewing time as the possible viewing time for the content; and

(2) supplying, if the possible viewing time for the content is already fixed, the content reproducer with the already fixed possible viewing time as the possible viewing time for the content,

wherein when the content receiver writes out the content to the removable recording medium, management server reference information indicating a location of the management server that fixes the possible viewing time is recorded on the removable recording medium together with the content, and

wherein if the management reference information is recorded on the removable recording medium when the content reproducer fixes the unfixed possible viewing time for the content, the request to fix the possible viewing time for the content is transmitted to the management server indicated by the management server reference information while a unit for fixing the possible viewing time provided in the content protection system is not used.

With the above-described configuration according to the present invention, a content receiver, a content reproducer, a management server, a content use system, a content use method, a method of write-out from the content receiver, a method of possible viewing time management on the content reproducer and a method of time limit fixation in the management server can be provided which enable synchronization between an expiration time limit for a content under a system for protecting contents using a copyright protection system (e.g., the DRM), to which content only a viewable period is assigned by the copyright protection system without setting an expiration time limit, and an expiration time limit for the same content under a different system for protecting contents (e.g., a CPS) even in a case where the content is exported to the different system for protecting contents by designating only the viewable period.

### BRIEF DESCRIPTION OF THE DRAWINGS

FIG. 1 is a diagram outlining the configurations of a content receiver and a content reproducer in a content use system in a first embodiment of the present invention;

FIG. 2 is a diagram showing the form of content management information on a removable medium in the first embodiment of the present invention;

FIG. 3 is a diagram showing the flow of operation of the content reproducer in the first embodiment of the present invention;

FIG. 4 is a diagram showing the operations and a communication sequence of the content receiver, the content reproducer and servers in the first embodiment of the present invention in a case where a content is written to an SD card before being reproduced by the content receiver and is reproduced by the content reproducer before being reproduced by the content receiver;

FIG. 5 is a diagram showing the operations and a communication sequence of the content receiver, the content reproducer and the servers in the first embodiment of the present invention in a case where a content is written to the SD card before being reproduced by the content receiver and is reproduced by the content receiver before being reproduced by the content reproducer; and

FIG. 6 is a diagram showing the operations and a communication sequence of the content receiver, the content reproducer and the servers in the first embodiment of the present invention in a case where a content is written to the SD card after being reproduced by the content receiver and is reproduced by the content reproducer.

### REFERENCE SIGNS LIST

100 Content server
101 DRM server
110 Content receiver
111 DRM decryption section
112 Output section
114 Possible viewing time obtaining section
115 Possible viewing time determination section
116 Secure clock
117 CPS encryption section
118 Viewing condition conversion section
119 Storage medium
120 Content reproducer
121 CPS decryption section
122 Output section
123 Reproduction control section
124 Possible viewing time obtaining section
125 Possible viewing time determination section
126 Secure clock
130 SD card
200 Content
201 Content key
202 Possible viewing time management information
203 Time limit fixing server URL
204 Purchase ID
205 Possible viewing time supply section
211 CPS key
212 CPS possible viewing time management information
223 Expiration time limit information
300 File entry
301 Content file name
302 Content attribute information
303 Possible viewing time management information
304 Time limit fixing server URL
305 Purchase ID
500 Content downloading
501, 534 Export license request
502, 535 Export license
503, 536 Writing to SD card
504, 537 Move of SD card
505, 524 Expiration time limit fixing request
506, 521, 531 Expiration time limit fixing processing
507, 525 Expiration time limit information
508, 526, 538 Reproduction
509, 520, 530 Reproduction license request
510, 522, 532 Reproduction license
511, 523, 533 Reproduction

### DETAILED DESCRIPTION

### First Embodiment

A first embodiment of the present invention will be described with reference to the accompanying drawings.

The following description is made of a case where a secure digital memory card (hereinafter referred to as “SD card”), which is an example of a removable medium, and Contents Protection for Removable Media (CPRM), which is a CPS for the SD card, are used.

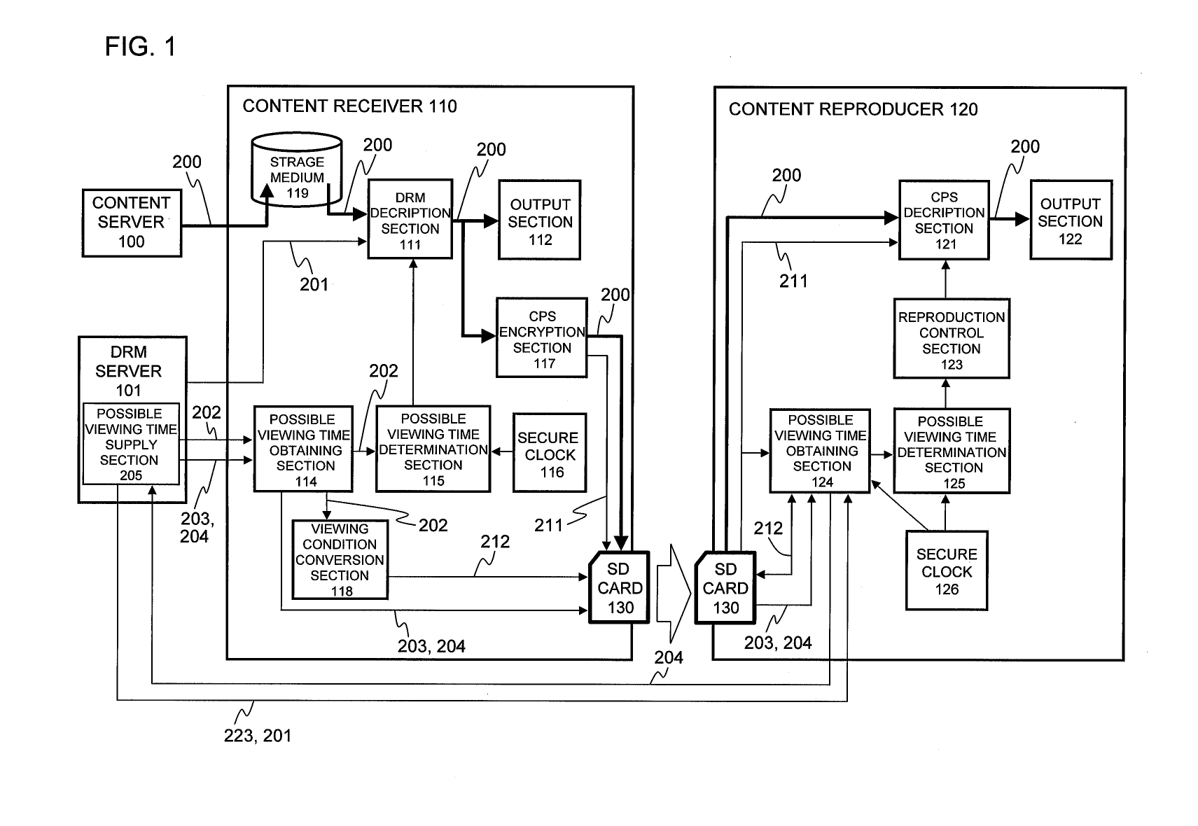

FIG. 1 is a diagram showing the configuration of a content use system in the first embodiment.

A content receiver 110 accesses through a network (not shown) a content server 100 and a DRM server 101 operated by a content business.

The operation of the content use system in the first embodiment and the configurations of the content receiver 110 and a content reproducer 120 will be described below.

The operations in “a case 1 where a content not yet reproduced is written to an SD card 130 by the content receiver 110, reproduced by the content reproducer 120 and then reproduced by the content receiver 110”, “a case 2 where a content not yet reproduced is written to the SD card 130 by the content receiver 110, reproduced by the content receiver 110 and then reproduced by the content reproducer 120” and “a case 3 where a content is written to the SD card 130 after being reproduced by the content receiver 110 and is reproduced by the content reproducer 120” of the content use system in the first embodiment will be described in order.

(Case 1 where a content not yet reproduced is written to the SD card by the content receiver, reproduced by the content reproducer and then reproduced by the content receiver)

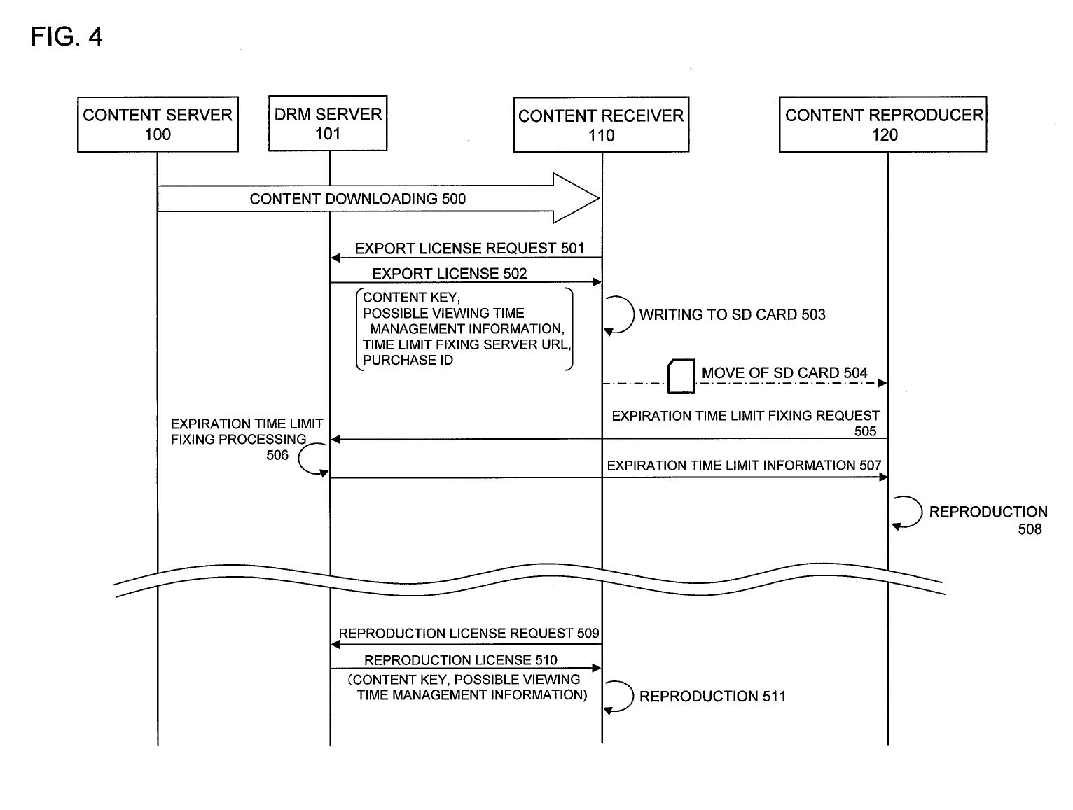

FIG. 4 shows the operations and a communication sequence of the content receiver 110, the content reproducer 120, the content server 100 and the DRM server 101 in a case where a content 200 is written to the SD card 130 before being reproduced by the content receiver 110 and is reproduced by the content reproducer 120 before being reproduced by the content receiver 110.

At the time of execution of downloading of a rental content specially designated by a user, the content receiver 110 receives an encrypted content 200 downloaded 500 from the content server 100 and records the downloaded content 200 on a storage medium 119 such as a hard disk or a memory incorporated in the content receiver 110.

When the user commands the content receiver 110 through a user interface section (not shown) or the like of the content receiver 110 to write out the content 200 stored on the storage medium 119, the content receiver 110 makes a request 501 of the DRM server 101 for an export license for export of the content 200.

The DRM server 101 receiving the export license request 501 transmits an export license 502 to the content receiver 110.

The export license 502 includes a time limit fixing server URL 203 and a purchase ID 204 as well as a content key 201 and possible viewing time management information 202 with respect to the content 200.

The export license 502 corresponds to an example of the write-out license in the present invention.

The content key 201 is a decryption key for decrypting the encrypted content 200. The possible viewing time management information 202 is information indicating a time limit before which the content 200 is viewable. The possible viewing time management information 202 includes a date/time at which viewing of the content 200 is started and a period of time in which the content 200 can be viewed. If a viewing start date/time is set, the user can view the content in the viewable period from the viewing start date/time. That is, if a viewing start date/time is set, an expiration time limit (e.g., to 13 o'clock August 7) indicating a time before which the content is viewable is determined from the viewing start date/time (e.g., 13 o'clock August 4) and the viewable period (e.g., 72 hours).

The expiration time limit indicating the time before which the content can be viewed corresponds to an example of the possible viewing time in the present invention.

However, in a case where the content 200 has never been reproduced in the content receiver 110, that is, the DRM server 101 has issued no reproduction license to the content receiver 110 with respect to the content 200, no viewing start date/time is designated and only a viewable period is designated in the possible viewing time management information 202.

Since in this case the export license request 501 is made in a state where the content 200 has never been reproduced in the content receiver 110, no viewing start date/time is set in the possible viewing time management information 202 included in the export license 502 at this time. A viewing start date/time is fixed only when the content 200 is first reproduced at a future time, and viewing of the content 200 in the viewable period from the viewing start date/time is then permitted.

Also, the time limit fixing server URL 203 represents the location of a management server which manages possible viewing times. In the first embodiment, the location indicated by the time limit fixing server URL 203 is the DRM server 101. Even at a request from the content reproducer 120 out of the area manageable by the DRM server 101, the DRM server 101 can fix an expiration time limit of the content indicated by the purchase ID 204 and notify the content reproducer 120 of the fixed expiration time limit.

The purchase ID 204 is information for identifying the content from the DRM system side when the content is exported from a DRM system, which is a content protection system, to a CPS, which is another content protection system. The purchase ID 204 includes authentication information for enabling the purchase ID 204 to be identified with reliability as information supplied from the DRM server 101.

The content receiver 110 reads out the encrypted content 200 from the storage medium 119 and decrypts the cryptogram in a DRM decryption section 111 by using the content key 201 obtained from the DRM server 101. A CPS encryption section 117 again executes on the decrypted content 200 encryption in a CPRM format according to the CPS for the SD card 130, writes the CPS-encrypted content 200 to the SD card 130, and performs writing 503 of a CPS key 211 used for decryption of the CPS-encrypted content 200 to the SD card 130 while associating the CPS key 211 with the content 200.

A viewing condition conversion section 118 in the content receiver 110 converts the possible viewing time management information 202 on the content 200 obtained from a possible viewing time supply section 205 in the DRM server 101 into CPS possible viewing time management information 212 in conformity with the CPS at the write-out destination, and records the CPS possible viewing time management information 212 in the SD card 130 while associating the CPS possible viewing time management information 212 with the content 200.

The CPS possible viewing time management information 212 includes information on a viewing start date/time and the viewable period. In the CPS possible viewing time management information 212, information in the possible viewing time management information 202 is taken over. That is, when the content 200 is exported to the SD card 130 without having undergone reproducing in the content receiver 110 as in this case, no viewing start date/time is designated and only the viewable period is designated in the possible viewing time management information. Accordingly, also in the CPS possible viewing time management information 212, no viewing start date/time is designated and only the viewable period is designated.

A possible viewing time obtaining section 114 in the content receiver 110 also records the time limit fixing server URL 203 and the purchase ID 204 in the SD card 130 by associating the time limit fixing server URL 203 and the purchase ID 204 with the content 200.

The SD card 130 corresponds to an example of the removable recording medium in the present invention; the time limit fixing server URL 203, to an example of the management server reference information in the present invention; and the purchase ID 204, to an example of the time limit synchronization management information in the present invention. Also, the CPS encryption section 117 that writes the content 200 to the SD card 130 and the possible viewing time obtaining section 114 that records the time limit fixing server URL 203 correspond to an example of the recording section in the present invention. Processing performed by the CPS encryption section 117 to write the content 200 to the SD card 130 and processing performed by the possible viewing time obtaining section 114 to record the time limit fixing server URL 203 in the SD card 130 correspond to an example of the recording step in the present invention. The CPS possible viewing time management information 212 recorded in the SD card 130, in which no viewing start date/time is designated, corresponds to an example of the information on an unfixed possible viewing time in the present invention.

Content management information in the SD card 130 will be described.

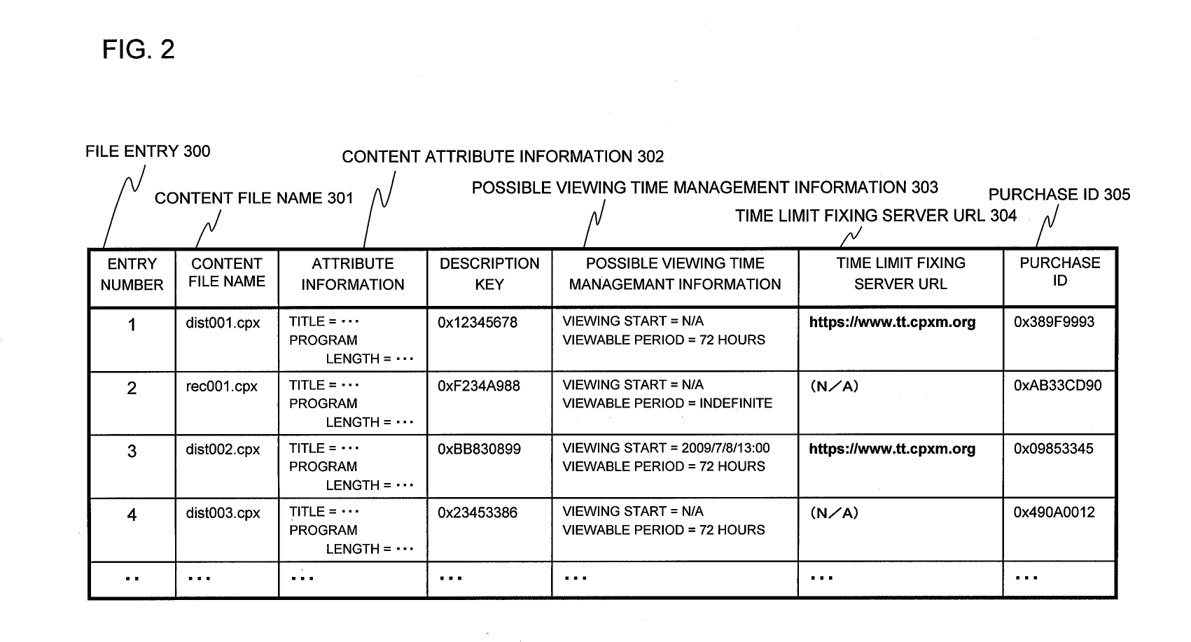

FIG. 2 is a diagram showing details of content management information in the SD card 130.

In content management information recorded in the SD card 130, management information on contents recorded in the SD card 130 is registered.

Each content recorded in the SD card 130 is individually identified through a file entry 300. A content file name 301, content attribute information 302, possible viewing time management information 303, time limit fixing server URL 304 and a purchase ID 305 are recorded as management information with respect to each content. No time limit fixing server URL 304 and no purchase ID 305 may be recorded for some content. In FIG. 2, “dist001.cpx” is shown as a file name of the content indicated by an entry number 1 in the file entry 300 and “https://www.tt.cpxm.org” is shown as the time limit fixing server URL 304. Also, “rec001.cpx” is shown as a file name of the content indicated by an entry number 2, and the time limit fixing server URL 304 for this content is expressed by “N/A” denoting nonexistence.

The possible viewing time management information 303 can include a viewing start date/time and a viewable period. In the first embodiment, no viewing start date/time is fixed before the content is viewed for the first time. In FIG. 2, an expression “Viewing start=N/A” indicates that no viewing start date/time is fixed.

In the content receiver 110, information on the content 200 is recorded in the content management information in the SD card 130 when the content 200 is written to the SD card 130. More specifically, information of the CPS possible viewing time management information 212, the time limit fixing server URL 203 and the purchase ID 204 are recoded as the possible viewing time management information 303, the time limit fixing server URL 304 and the purchase ID 305, respectively, in the content management information for the content 200.

Since in this case the content 200 is written to the SD card 130 without having undergone reproducing in the content receiver 110, no viewing start date/time is designated and only the viewable period is designated in the CPS possible viewing time management information 212, and the content management information on the content 200 is described like that for the content indicated by the entry number 1 of the file entry 300 in FIG. 2.

A process in which the content 200 written to the SD card 130 as described above is moved into the separate content reproducer 120 as shown at 504 and is reproduced by the content reproducer 120 before being reproduced by the content receiver 110 for the first time will next be described.

The content reproducer 120 is a content viewing terminal having the function to reproduce a recording made in the CPRM format in the SD card. When the content 200 recorded on the SD card 130 inserted in the content reproducer 120 is reproduced, a possible viewing time obtaining section 124 first reads out from the SD card 130 the CPS possible viewing time management information 212, the time limit fixing server URL 203 and the purchase ID 204 associated with the content 200.

The possible viewing time obtaining section 124 sends the purchase ID 204 to the DRM server 101 designated by the time limit fixing server URL 203 and makes a request 505 of the DRM server 101 to fix an expiration time limit for the content 200.

The possible viewing time supply section 205 in the DRM server 101 as a management server, receives the expiration time limit fixing request 505 from the content reproducer 120, confirms that the purchase ID 204 is a purchase ID provided from the DRM server 101 by checking the authentication information contained in the purchase ID 204, and thereafter determines whether or not a viewing start date/time has been fixed for the content designated by the purchase ID 204. Since no viewing start date/time has been fixed for the content 200, the possible viewing time supply section 205 sets the present time as a viewing start date/time to fix an expiration time limit as shown at 506, and notifies, as shown at 507, the content reproducer 120 of expiration time limit information 223 including the viewing start date/time to the present time as well as the viewable period.

The expiration time limit fixing request 505 corresponds to an example of the possible viewing time fixing request in the present invention. The viewing start date/time set to the present time and the viewable period correspond to an example of the fixed possible viewing time in the present invention. Processing performed by the possible viewing time obtaining section 124 to transmit the expiration time limit fixing request 505 to the DRM server 101 corresponds to an example of the possible viewing time obtaining step in the present invention. Processing performed by the DRM server 101 to transmit the expiration time limit information 223 to the content reproducer 120 according to the expiration time limit fixing request 505 corresponds to the possible viewing time supply step in the present invention.

The possible viewing time obtaining section 124 in the content reproducer 120 converts the expiration time limit information 223 obtained from the DRM server 101 into CPS possible viewing time management information 212 in accordance with CPRM, writes the CPS possible viewing time management information 212 to the SD card 130 and also stores the CPS possible viewing time management information 212 in itself. The possible viewing time obtaining section 124 then obtains the expiration time limit for the content 200 from the viewing start date/time and the viewable period and inputs the expiration time limit to a possible viewing time determination section 125.

Since the CPS possible viewing time management information 212 is converted at this time from the expiration time limit information 223 including the fixed viewing start date/time, the fixed viewing start date/time is designated therein. Accordingly, the possible viewing time management information 303 in the SD card 130 with respect to the content 200 of the content management information is rewritten, as from the information on the content indicated by the entry number 1 in the file entry 300 in FIG. 2 to the information on the content indicated by the entry number 3.

The possible viewing time determination section 125 reads out present date/time information from a secure clock 126 and compares the present date/time read out and the expiration time limit for the content 200 obtained from the possible viewing time obtaining section 124 to determine whether or not the present time is beyond the expiration time limit.

In this case, since the present time is set as the viewing start data/time, the possible viewing time determination section 125 determines that the present time is not beyond the expiration time limit, and notifies a reproduction control section 123 that reproduction of the content 200 can be performed.

A CPS decryption section 121 receives from the reproduction control section 123 the notice indicating that reproduction of the content 200 can be performed, and reads out the content 200 and the CPS key 211 from the SD card 130. The CPS decryption section 121 decrypts the encrypted content 200 with the CPS key and outputs the decrypted content 200 to an output section 122. The output section 122 decodes the encoded content 200 and outputs the decoded content 200 as an AV signal, thus reproducing the content 200 as indicated at 508.

Thereafter, in the content receiver 110, the content 200 stored on the storage medium 119, which corresponds to the content 200 written to the SD card 130, is reproduced for the first time.

The user commands the content receiver 110 through the user interface section or the like of the content receiver 110 to reproduce the content 200 stored on the storage medium 119. The content receiver 110 then makes a request 509 of the DRM server 101 for a reproduction license for reproduction of the content 200.

A reproduction license 510 transmitted from the DRM server 101 receiving the reproduction license request 509 contains the content key 201 for decryption of the content 200 and the possible viewing time management information 202 on the content 200. The possible viewing time management information 202 includes the viewing start date/time and the viewable period with respect to the content 200.

Since the DRM server 101 receiving the reproduction license request 509 has entered the predetermined value set with respect to the content 200 as a viewable period in the possible viewing time management information 202 and has fixed a viewing start date/time for the content 200 by expiration time limit fixing processing 506, it enters the fixed viewing start date/time, i.e., the date/time previously sent as expiration time limit information 507 to the content reproducer 120, if the present time is not beyond the expiration time limit.

The possible viewing time supply section 205 in the DRM server 101 transmits the thus-prepared possible viewing time management information 202 to the content receiver 110 by including the possible viewing time management information 202 together with the content key 201 in the reproduction license 510.

The possible viewing time obtaining section 114 in the content receiver 110 then receives the possible viewing time management information 202 from the DRM server 101.

The possible viewing time obtaining section 114 obtains the expiration time limit for the content 200 from the viewing start date/time and the viewable period entered in the possible viewing time management information 202 obtained from the DRM server 101 and inputs the expiration time limit to a possible viewing time determination section 115.

The possible viewing time determination section 115 reads out present date/time information from a secure clock 116 and compares the present date/time read out and the expiration time limit obtained from the possible viewing time obtaining section 114 to determine whether or not the present time is beyond the expiration time limit. If the possible viewing time determination section 115 determines that the present time is not beyond the expiration time limit, it instructs the DRM decryption section 111 to decrypt the encrypted content 200.

The DRM decryption section 111 instructed to perform decryption reads out the content 200 from the storage medium 119, decrypts the cryptogram on the content 200 with the content key 201 obtained from the DRM server 101 and outputs the content 200 to an output section 112.

The output section 112 decodes the encoded content 200 and outputs the decoded content 200 as a video/audio signal, thus reproducing the content 200 as indicated at 511.

(Case 2 where a content not yet reproduced is written to the SD card by the content receiver, reproduced by the content receiver and then reproduced by the content reproducer)

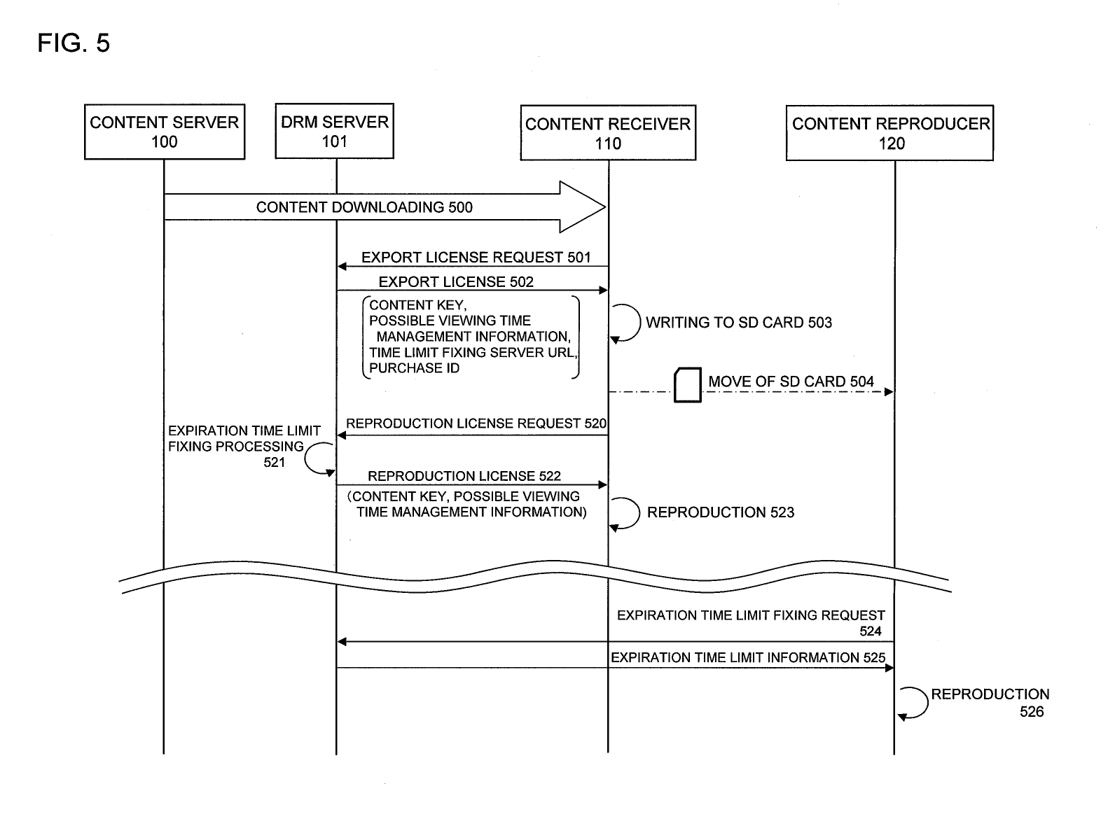

FIG. 5 shows the operations and a communication sequence of the content receiver 110, the content reproducer 120, the content server 100 and the DRM server 101 in a case where the content 200 is written to the SD card 130 before being reproduced by the content receiver 110 and is reproduced by the content receiver 110 before being reproduced by the content reproducer 120. The same components and processing portions as those shown in FIG. 4 are indicated by the same reference numerals.

The content 200 is written to the SD card 130 before being reproduced by the content receiver 110 for the first time, as in the case shown in FIG. 4. Therefore, processing from writing of the content 200 to the SD card 130 to moving 504 of the SD card 130 is the same as that in the case shown in FIG. 4. The description of the same processing will not be repeated. Description will be made below of processing after moving 504 the SD card 130 into the content reproducer 120.

In this case, after performing writing 503 of the content 200 to the SD card 130, the content 200 is reproduced by the content receiver 110 before being reproduced by the content reproducer 120.

The user commands the content receiver 110 through the user interface section or the like of the content receiver 110 to reproduce the content 200 stored on the storage medium 119. The content receiver 110 then makes a request 520 of the DRM server 101 for a reproduction license for reproduction of the content 200.

A reproduction license 522 transmitted from the DRM server 101 receiving the reproduction license request 520 contains the content key 201 for decryption of the encrypted content 200 and the possible viewing time management information 202 on the content 200. The possible viewing time management information 202 in this case includes the viewing start date/time and the viewable period with respect to the content 200.

The possible viewing time supply section 205 in the DRM server 101 receiving the reproduction license request 520 enters the predetermined value set with respect to the content 200 as a viewable period in the possible viewing time management information 202. Since the reproduction license request 520 is the first reproduction license request from the content receiver 110 with respect to the content 200, and since no expiration time limit fixing request has been received from the content reproducer 120, no viewing start date/time has been fixed. The possible viewing time supply section 205 therefore sets the present time as a viewing start date/time to fix an expiration time limit as shown at 521, and enters the present time as a viewing start date/time.

The DRM server 101 transmits the thus-prepared possible viewing time management information 202 to the content receiver 110 by including the possible viewing time management information 202 together with the content key 201 in the reproduction license 522.

The possible viewing time obtaining section 114 in the content receiver 110 then receives the possible viewing time management information 202 from the DRM server 101.

The possible viewing time obtaining section 114 obtains the expiration time limit for the content 200 from the viewing start date/time and the viewable period entered in the possible viewing time management information 202 obtained from the DRM server 101 and inputs the expiration time limit to the possible viewing time determination section 115.

The possible viewing time determination section 115 reads out present date/time information from the secure clock 116 and compares the present date/time read out and the expiration time limit obtained from the possible viewing time obtaining section 114 to determine whether or not the present time is beyond the expiration time limit.

In this case, since the present time is set as a viewing start date/time, the possible viewing time determination section 115 determines that the present time is not beyond the expiration time limit, and instructs the DRM decryption section 111 to decrypt the encrypted content 200.

The DRM decryption section 111 instructed to perform decryption reads out the content 200 from the storage medium 119, decrypts the cryptogram on the content 200 with the content key 201 obtained from the DRM server 101 and outputs the content 200 to the output section 112.

The output section 112 decodes the encoded content 200 and outputs the decoded content 200 as a video/audio signal, thus reproducing the content 200 as indicated at 523.

Thereafter, in the content reproducer 120, the content 200 recoded on the SD card 130 is reproduced.

At the time of reproducing the content 200 recorded on the SD card 130 inserted in the content reproducer 120, the possible viewing time obtaining section 124 first reads out of the SD card 130 the CPS possible viewing time management information 212, time limit fixing server URL 203 and purchase ID 204 associated with the content 200.

The possible viewing time obtaining section 124 sends the purchase ID 204 to the DRM server 101 designated by the time limit fixing server URL 203 and makes a request 524 of the DRM server 101 to fix an expiration time limit for the content 200.

The possible viewing time supply section 205 in the DRM server 101 confirms that the purchase ID 204 is a purchase ID provided from the DRM server 101 by checking the authentication information contained in the purchase ID 204, and thereafter determines whether or not a viewing start date/time has been fixed for the content designated by the purchase ID 204.

Since a viewing start date/time has already been fixed for the content 200 in expiration time limit fixing processing 521, the possible viewing time supply section 205 notifies, as indicated at 525, the viewable period and the fixed viewing start date/time, i.e., the viewing start date/time sent to the content receiver 110 in advance by being included in the reproduction license 522, as expiration time limit information 223, to the content reproducer 120 if the present time is not beyond the expiration time limit.

The possible viewing time obtaining section 124 in the content reproducer 120 converts the expiration time limit information 223 obtained from the DRM server 101 into CPS possible viewing time management information 212 in accordance with CPRM, writes the CPS possible viewing time management information 212 to the SD card 130 and also stores the CPS possible viewing time management information 212 in itself. The possible viewing time obtaining section 124 then obtains the expiration time limit for the content 200 from the viewing start date/time and the viewable period and inputs the expiration time limit to the possible viewing time determination section 125.

Since the CPS possible viewing time management information 212 is converted at this time from the expiration time limit information 223 including the fixed viewing start date/time, the fixed viewing start date/time is designated therein. Accordingly, the possible viewing time management information 303 in the SD card 130 with respect to the content 200 of the content management information is rewritten, as from the information on the content indicated by the entry number 1 in the file entry 300 in FIG. 2 to the information on the content indicated by the entry number 3.

The possible viewing time determination section 125 reads out present date/time information from the secure clock 126 and compares the present date/time read out and the expiration time limit for the content 200 obtained from the possible viewing time obtaining section 124 to determine whether or not the present time is beyond the expiration time limit.

If the possible viewing time determination section 125 determines that the present time is not beyond the expiration time limit for the content 200, it notifies the reproduction control section 123 that reproduction of the content 200 can be performed.

When the CPS decryption section 121 receives from the reproduction control section 123 the notice indicating that reproduction of the content 200 can be performed, it reads out the content 200 and the CPS key 211 from the SD card 130. The CPS decryption section 121 decrypts the content 200 with the CPS key 211 and outputs the decrypted content 200 to the output section 122. The output section 122 decodes the encoded content 200 and outputs the decoded content 200 as an AV signal, thus reproducing the content 200 as indicated at 526.

(Case 3 where a content is written to the SD card after being reproduced by the content receiver and is reproduced by the content reproducer)

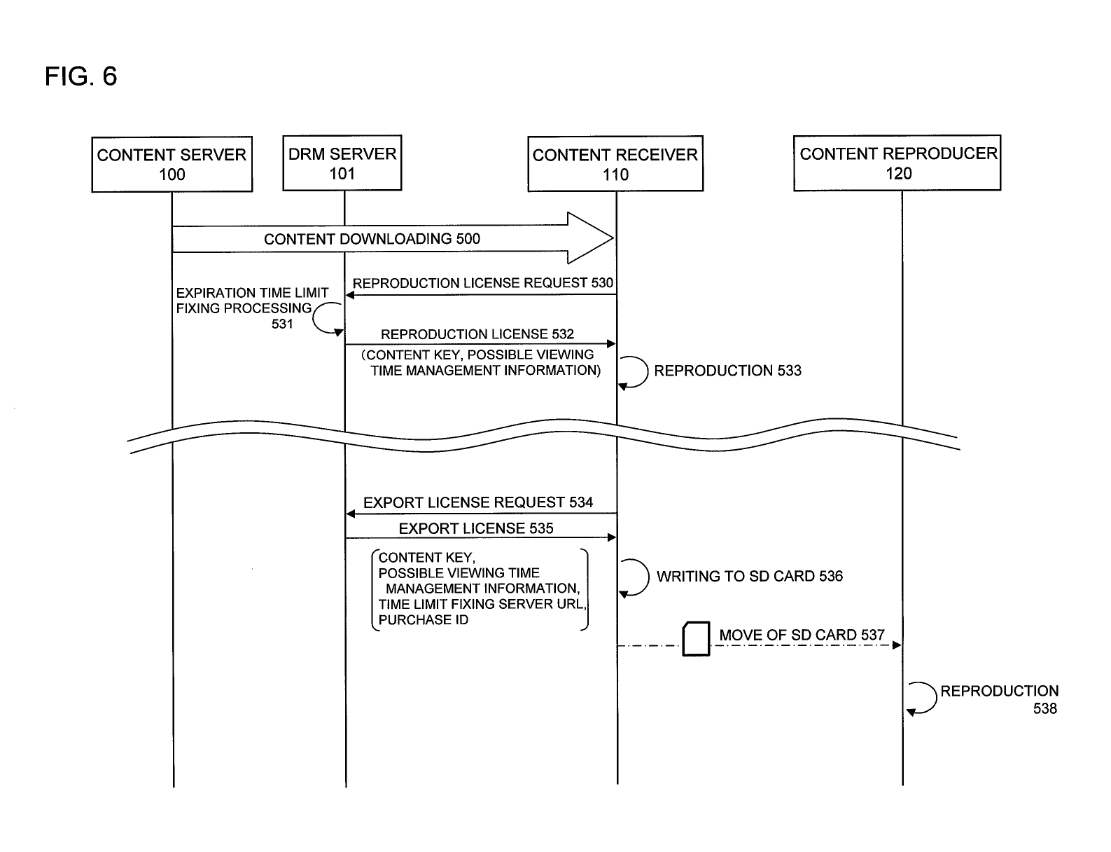

FIG. 6 shows the operations and a communication sequence of the content receiver 110, the content reproducer 120, the content server 100 and the DRM server 101 in a case where the content 200 is written to the SD card 130 after being reproduced by the content receiver 110 and is reproduced by the content reproducer 120. The same components and processing portions as those shown in FIG. 4 are indicated by the same reference numerals.

In this case, the content receiver 110 reproduces the content 200 by itself before it writes to the SD card 130 the content 200 downloaded 500 from the content server 100 and recorded on the storage medium 119.

Before writing the downloaded content 200 to the SD card 130, the user commands the content receiver 110 through the user interface section or the like of the content receiver 110 to reproduce the content 200 stored on the storage medium 119. The content receiver 110 then makes a request 530 of the DRM server 101 for a reproduction license for reproduction of the content 200.

A reproduction license 532 transmitted from the DRM server 101 receiving the reproduction license request 530 contains the content key 201 for decryption of the encrypted content 200 and the possible viewing time management information 202 on the content 200. The possible viewing time management information 202 includes the viewing start date/time and the viewable period with respect to the content 200.

The possible viewing time supply section 205 in the DRM server 101 receiving the reproduction license request 530 enters the predetermined value set with respect to the content 200 as a viewable period in the possible viewing time management information 202. Since the reproduction license request 530 is the first reproduction license request from the content receiver 110 with respect to the content 200, and since no expiration time limit fixing request has been received from the content reproducer 120, no viewing start date/time has been fixed. The possible viewing time supply section 205 therefore sets the present time as a viewing start date/time to fix an expiration time limit as shown at 531, and enters the present time as a viewing start date/time.

The DRM server 101 transmits the thus-prepared possible viewing time management information 202 to the content receiver 110 together with the content key 201.

The possible viewing time obtaining section 114 in the content receiver 110 then receives the possible viewing time management information 202 from the DRM server 101.

The possible viewing time obtaining section 114 obtains the expiration time limit for the content 200 from the viewing start date/time and the viewable period entered in the possible viewing time management information 202 obtained from the DRM server 101 and inputs the expiration time limit to the possible viewing time determination section 115.

The possible viewing time determination section 115 reads out present date/time information from the secure clock 116 and compares the present date/time read out and the expiration time limit obtained from the possible viewing time obtaining section 114 to determine whether or not the present time is beyond the expiration time limit.

In this case, since the present time is set as a viewing start date/time, the possible viewing time determination section 115 determines that the present time is not beyond the expiration time limit, and instructs the DRM decryption section 111 to decrypt the encrypted content 200.

The DRM decryption section 111 instructed to perform decryption reads out the content 200 from the storage medium 119, decrypts the cryptogram on the content 200 with the content key 201 obtained from the DRM server 101 and outputs the content 200 to the output section 112.

The output section 112 decodes the encoded content 200 and outputs the decoded content 200 as a video/audio signal, thus reproducing the content 200 as indicated at 533.

Thus, the content receiver 110 can be capable of viewing in a predetermined time period from the point in time at which the content is viewed for the first time irrespective of the date/time at which the content 200 is obtained from the content server 100.

Thereafter, the content receiver 110 writes the content 200 to the SD card 130.

When the user commands the content receiver 110 through the user interface section or the like of the content receiver 110 to write out the content 200 stored on the storage medium 119, the content receiver 110 makes a request 534 of the DRM server 101 for an export license for export of the content 200.

The DRM server 101 receiving the export license request 534 transmits an export license 535 to the content receiver 110.

The export license 535 includes the time limit fixing server URL 203 and the purchase ID 204 as well as the content key 201 and the possible viewing time management information 202 with respect to the content 200.

Since the possible viewing time supply section 205 in the DRM server 101 receiving the export license request 534 has entered the predetermined value set with respect to the content 200 as a viewable period in the possible viewing time management information 202 and has fixed a viewing start date/time for the content 200 by expiration time limit fixing processing 531, it enters the fixed viewing start date/time if the present time is not beyond the expiration time limit.

The content receiver 110 reads out the encrypted content 200 from the storage medium 119 and decrypts the cryptogram in the DRM decryption section 111 by using the content key 201 obtained from the DRM server 101. The CPS encryption section 117 again executes on the decrypted content 200 encryption in the CPRM format according to the CPS for the SD card 130, writes the CPS-encrypted content 200 to the SD card 130, and performs writing 536 of the CPS key 211 used for decryption of the CPS-encrypted content 200 to the SD card 130 while associating the CPS key 211 with the content 200.

The viewing condition conversion section 118 in the content receiver 110 converts the possible viewing time management information 202 on the content 200 obtained from the DRM server 101 into CPS possible viewing time management information 212 in conformity with the CPS at the write-out destination, and records the CPS possible viewing time management information 212 in the SD card 130 while associating the CPS possible viewing time management information 212 with the content 200.

The CPS possible viewing time management information 212 includes information on the viewing start date/time and the viewable period. In the CPS possible viewing time management information 212, information in the possible viewing time management information 202 is taken over.

In this case, since the fixed viewing start date/time is designated in the possible viewing time management information 202, the fixed viewing start date-time is also set in the CPS possible viewing time management information 212. Accordingly, the possible viewing time management information 303 in the SD card 130 with respect to the content 200 of the content management information is entered like that with respect to the content indicated by the entry number 3 in the file entry 300 in FIG. 2.

The information on the fixed viewing start date/time and the viewable period recorded in the SD card 130 corresponds to an example of the already fixed possible viewing time.

Subsequently, the SD card 130 to which the content 200 has been written in the above-described way is moved into the separate content reproducer 120, as indicated at 537, and the content 200 is reproduced by the content reproducer 120.

When the content 200 recorded on the SD card 130 inserted in the content reproducer 120 is reproduced, the possible viewing time obtaining section 124 first reads out from the SD card 130 the CPS possible viewing time management information 212 associated with the content 200.

Since the viewing start date/time is designated in the CPS possible viewing time management information 212, the possible viewing time obtaining section 124 obtains the expiration time limit from the viewing start date/time and the viewable period included in the CPS possible viewing time management information 212 and inputs the expiration time limit to the possible viewing time determination section 125.

The possible viewing time determination section 125 reads out present date/time information from the secure clock 126 and compares the present date/time read out and the expiration time limit for the content 200 obtained from the possible viewing time obtaining section 124 to determine whether or not the present time is beyond the expiration time limit.

If the possible viewing time determination section 125 determines that the present time is not beyond the expiration time limit for the content 200, it notifies the reproduction control section 123 that reproduction of the content 200 can be performed.

When the CPS decryption section 121 receives from the reproduction control section 123 the notice indicating that reproduction of the content 200 can be performed, it reads out the content 200 and the CPS key 211 from the SD card 130. The CPS decryption section 121 decrypts the content 200 with the CPS key 211 and outputs the decrypted content 200 to the output section 122. The output section 122 decodes the encoded content 200 and outputs the decoded content 200 as an AV signal, thus reproducing the content 200 as indicated at 538.

In this case, since the fixed viewing start date/time is recorded in the SD card 130, and since an expiration time limit is set for the content 200, there is no need to transmit an expiration time limit fixing request as in the cases shown in FIGS. 4 and 5, and the content reproducer 120 decodes and reproduces the content 200 in the SD card 130 without accessing the DRM server 101, as described above.

The time limit fixing server URL 203 and the purchase ID 204 written on the SD card 130 by the content receiver 110 are necessary information for enabling the content reproducer 120 to fix an expiration time period for the content 200 in a case where no expiration time limit has been fixed for the content 200 on the SD card 130.

In the case of the operation sequence shown in FIG. 6, an expiration time limit for the content 200 is already fixed when the content receiver 110 performs writing 536 to the SD card 130 and there is, therefore, no need to write the time limit fixing server URL 203 and the purchase ID 204 to the SD card 130 with respect to the content 200. Therefore, the DRM server 101 may recognize that the reproduction license 532 had been transmitted to the content receiver 110 that has transmitted the export license request 534 to the DRM server 101, and may omit including the time limit fixing server URL 203 and the purchase ID 204 in the export license 535 to be transmitted at the export license request 534.

The operation at the time of possible viewing time determination processing in the content reproducer 120 will next be described in detail.

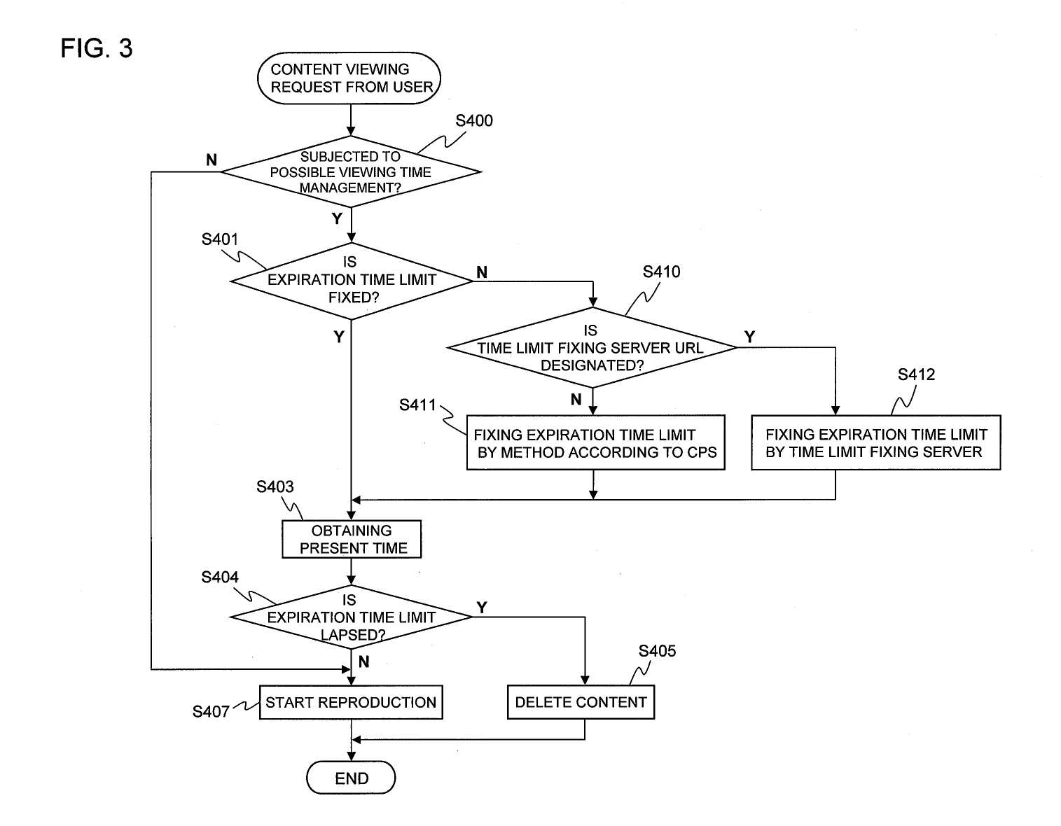

FIG. 3 is a diagram showing the operation flow at the time of possible viewing time determination in the content reproducer 120.

At the time of starting reproduction of a particular content stored in the SD card 130 at a command from the user, the possible viewing time obtaining section 124 obtains the management information on the content.

As described above, content management information, such as shown in FIG. 2, about contents recorded in the SD card 130 is registered in the SD card 130.

When reproduction of the content is started, the possible viewing time obtaining section 124 reads out the management information with the entry number matching the content in the file entry 300 from the content management information in the SD card 130.

Possible viewing time management information 303 is included in this management information. The possible viewing time obtaining section 124 first determines, on the basis of the possible viewing time management information 303, whether or not the content to be reproduced is a content under possible viewing time management (step S400).

More specifically, if both a viewing start date/time and a viewable period are entered in the possible viewing time management information 303, or if only a viewable period is entered, it is determined that the content is under possible viewing time management, and the process advances to step S401. If no viewing start date/time and no viewable period are entered in the possible viewing time management information 303, it is determined that the content is not under possible viewing time management, and the process moves to step S407.

The content at the entry number 2 in the file entry 300 in FIG. 2 is not under possible viewing time management, while at least a viewable period is entered for each of the contents at the entry numbers 1, 3, and 4 and these contents are under possible viewing time management.

Next, the possible viewing time obtaining section 124 determines, with respect to the contents under possible viewing time management, whether or not an expiration time limit has been fixed, that is, a viewing start date/time has been fixed (step S401). If a viewing start date/time is designated in the possible viewing time management information 303, it is determined that the viewing start date/time is fixed, and the process advances to step S403. If no viewing start date/time is fixed, the process moves to step S410.

For the content at the entry number 3 in the file entry 300 in FIG. 2, a viewing start date/time is designated. For each of the contents at the entry numbers 1 and 4, no viewing start date/time is designated.

In step S410, the possible viewing time obtaining section 124 reads out of the content management information the time limit fixing server URL 304 for the content to be reproduced, and determines whether or not a significant URL is entered in the time limit fixing server URL 304. If no significant URL is entered, an expiration time limit is fixed by a method specified in accordance with the CPS (step S411). That is, a content viewing start date/time is determined in the content reproducer 120 by using the time indicated in the secure clock 126, the possible viewing time management information 303 of the content management information in the SD card 130 is updated, and the determined viewing start date/time is stored in the possible viewing time obtaining section 124.

The expiration time limit fixing method specified in accordance with the CPS corresponds to an example of the time limit fixing unit for fixing a possible viewing time provided in the system for protecting contents in the present invention.

Also in a case where no DRM server exists at an address indicated by the time limit fixing server URL 304 for the content, an expiration time limit is determined in the content reproducer 120 in the same way (step S411).

For the content at the entry number 4 in the file entry 300 in FIG. 2, no significant URL is entered in the time limit fixing server URL 304. For the content at the entry number 1, a significant URL is entered in the time limit fixing server URL 304.

If it is determined in step S410 that a significant URL is entered in the time limit fixing server URL 304, the process moves to step S412. In step S412, the purchase ID 305 is sent to the server indicated by the URL designated in the time limit fixing server URL 304, and a request is made of the server to fix an expiration time limit for the content. In the first embodiment, the URL of the DRM server 101 is entered in the time limit fixing server URL 304 for the content at the entry number 1 in the file entry 300 in FIG. 2. Accordingly, the possible viewing time obtaining section 124 makes a request of the DRM server 101 to fix an expiration time limit (expiration time limit fixing requests 505 and 524 in FIGS. 4 and 5).

If no viewing start date/time is fixed with respect to the designated purchase ID 305 (if the DRM server 101 has received no reproduction license request, and if an expiration time limit fixing request is made for the first time), the DRM server 101 as a management server designates the present time as a viewing start date/time and notifies the content reproducer 120 of expiration time limit information including the viewing start date/time and the viewable period. If a reproduction license request or an expiration time limit fixing request has been made with respect to the same purchase ID, and if a viewing start date/time has been fixed, the DRM server 101 notifies the content reproducer 120 of the fixed viewing start date/time and the viewable period.

The possible viewing time obtaining section 124 obtains a viewing start date/time and a viewable period by the method in step S411 or step S412, thereafter obtains an expiration time limit for the content from the viewing start date/time and the viewable period and inputs the expiration time limit to the possible viewing time determination section 125. The possible viewing time determination section 125 then makes a determination with respect to the expiration time limit in steps S403 and S404.

The possible viewing time determination section 125 obtains the present time from the secure clock 126 (step S403).

The possible viewing time determination section 125 compares the expiration time limit input from the possible viewing time obtaining section 124 with the present time obtained in step S403 and determines whether or not the present time is beyond the expiration time limit (step S404). If the present time is not beyond the expiration time limit, the process advances to step S407 and the CPS decryption section 121 is instructed to perform the decrypting operation, thereby starting reproduction of the content. Conversely, if the present time is beyond the expiration time limit, the content is deleted (step S405).

To prevent unauthorized viewing performed by omitting access to the DRM server 101 as a management server when the content receiver 110 records the time limit fixing server URL 203 and the purchase ID 204 in the SD card 130 while associating the URL and the ID with the content 200 at the time of writing 503 to the SD card 130 shown in FIG. 4 or 5, the CPS encryption section 117 in the content receiver 110 may write the CPS key 211 to the SD card 130 after encrypting the CPS key 211. As a key for this encryption, the content key 201 of the content 200 is used. Doing so necessitates accessing the DRM server 101 to obtain the key for decryption of the encrypted CPS key 211 at the time of reproduction of the content 200 on the SD card 130 performed afterward, thus ensuring access to the DRM server.

In such a case, the DRM server 101 sends the content key 201 of the content 200 corresponding to the purchase ID 204 to the content reproducer 120 if the present time is not beyond the expiration time limit at the time of transmitting the expiration time limit information to the content reproducer 120 (expiration time limit information 507 or 525 in FIGS. 4 and 5) at an expiration time limit fixing request from the content reproducer 120.

When receiving the content key 201 from the DRM server 101, the possible viewing time obtaining section 124 reads out the encrypted CPS key 211 from the SD card 130, decrypts the CPS key 211 with the content key 201 and writes back the decrypted CPS key 211 to the SD card 130.

Processing performed by the CPS encryption section 117 in the content receiver 110 to encrypt the CPS key 211 as described above corresponds to an example of the encrypting step in the present invention. Processing performed by the possible viewing time obtaining section 124 in the content reproducer 120 to decrypt the encrypted CPS key 211 with the content key 201 as described above corresponds to an example of the decrypting step in the present invention.

In the above-described case where the content key 201 is used as the key with which the CPS encryption section 117 in the content receiver 110 encrypts the CPS key 211 at the time of writing the CPS key 211 to the SD card 130, values obtained by converting the content key 201 by a unidirectional function such as a hash function may be used. Specifications of the unidirectional function may be prepared in advance in common between the content receiver 110 and the content reproducer 120 to enable the content reproducer 120 to obtain the same key as that in encryption in the content receiver 110 by making the same conversion of the content key 201 received from the DRM server 101. In this way, risks against security can be reduced in comparison with the case of using the DRM content key in the original form. As the above-described unidirectional function, MD5, SHA-1, SHA-256 or the like is applicable. However, examples of the unidirectional function are not limited to these.

Further, as a key with which the CPS key 211 is encrypted, a bit sequence formed by concatenating a unique medium ID for the removable medium to which the content is to be written (the SD card 130 in the first embodiment) with the content key 201 may be used. In the content reproducer 120, the same key as that used at the time of encryption can also be obtained by reading out the unique medium ID from the removable medium and concatenating the medium ID with the content key 201 received from the DRM server 101. In a case where unauthorized copying or moving of the content and the encrypted CPS key recorded on the removable medium onto a different medium is performed, the key cannot be decrypted because of the difference between the unique IDs read out from the removable media, thus achieving prevention of unauthorized use.

The first embodiment has been described by assuming that possible viewing time management information designating an expiration time limit for a content is represented by a viewing start date/time and a viewable period. However, possible viewing time management information may be represented by information different from the above-described sorts of information. For example, an expiration time limit (a time limit before which viewing can be performed) may be used instead of a viewing start date/time, and an expiration time limit and a viewable period may represent possible viewing time management information. In a case where an expiration time limit is used instead of a viewing start date/time, a state where no expiration time limit is fixed is expressed by designating only a viewable period and by designating no expiration time limit, and information on an expiration time limit is designated when the expiration time limit is fixed.

Also, the first embodiment has been described by assuming that the DRM server 101 manages viewing licenses and possible viewing times. However, a different configuration may alternatively be adopted in which a server which manages viewing licenses and a server which manages possible viewing times are provided separately from each other. Also in a case where such a configuration is adopted, the content reproducer 120 can access the server managing possible viewing times by means of the time limit fixing server URL 203 recorded in the SD card 130.

Also, while the first embodiment has been described by assuming that the content receiver 110 itself has the function of reproducing the content 200, the content receiver 110 may alternatively be an export-only device having no function to reproduce a content by itself. In such a case, when a plurality of different content reproducers 120 reproduce the same content written to a plurality of removable media, expiration time limits for the contents recorded on the removable media can also be synchronized with each other.

As described above, according to the present invention, even in a case where a rental content under DRM management is viewed by being exported to a CPS other than the DRM, a time limit before which viewing can be performed (expiration time limit) under DRM management and a time limit before which viewing can be performed under CPS management can be synchronized with each other.

Implementation of the possible viewing time obtaining section 114, the possible viewing time determination section 115 and the viewing condition conversion section 118 in the content receiver 110, the possible viewing time obtaining section 124 and the possible viewing time determination section 125 in the content reproducer 120, the possible viewing time supply section 205 in the DRM server 101 and other sections may be made in software form such that a CPU executes a program to realize the corresponding functions. In such a case, the system can be provided by using a reduced number of component parts and can be easily changed according to changes in specifications in comparison with the system implemented only in hardware form.

In particular, the possible viewing time obtaining section 114, the possible viewing time obtaining section 124 and the possible viewing time supply section 205 are made capable of being easily changed according to changes in data format recorded in removable media or changes in communication format between the units if they are implemented in software form.

A program according to the present invention is a program for causing a computer to execute the operation of the recording step of recording, on the removable recording medium, together with the content, management server reference information indicating a location of a management server which fixes the possible viewing time in place of a unit for fixing the possible viewing time provided in the content protection system, when the content is written out to the removable recording medium of the method of write-out from the content receiver and is a program which operates in cooperation with the computer.

A program according to the present invention is a program for causing a computer to execute the operation of the possible viewing time obtaining step of obtaining the possible viewing time by making a request of a management server indicated by management server reference information to fix the possible viewing time for the content without using a unit for fixing the possible viewing time provided in the content protection system, if the management server reference information indicating a location of the management server that fixes the possible viewing time is recorded on the removable recording medium at the time of fixing the possible viewing time for the content that has an unfixed possible viewing time of the method of possible viewing time management on the content reproducer and is a program which operates in cooperation with the computer.

A program according to the present invention is a program for causing a computer to execute the operation of the possible viewing time supplying step of supplying the possible viewing time for the content after a request to fix the possible viewing time has been received from the content reproducer, including: (1) fixing the possible viewing time for the content with reference to a present time if the possible viewing time for the content is still unfixed, recording the fixed possible viewing time for the content, and supplying the content reproducer with the fixed possible viewing time as the possible viewing time for the content; and (2) supplying, if the possible viewing time for the content is already fixed, the content reproducer with the already fixed possible viewing time as the possible viewing time for the content, of the method of time limit fixation in the management server and is a program which operates in cooperation with the computer.

The “operation of the steps” according to the present invention means the operation of all or a part of the steps.

A form of use of the program according to the present invention may be a form in which the program is recorded on a recording medium such as a ROM readable by a computer and operates in cooperation with the computer.

A form of use of the program according to the present invention may be a form in which the program is transmitted through a transmission medium such as the Internet or a transmission medium such as light or a radio wave, read by a computer, and operates in cooperation with the computer.

The computer according to the present invention explained above is not limited to pure hardware such as a CPU and may include firmware, an OS, and peripheral equipment.

As explained above, the configuration of the present invention may be realized in terms of software or may be realized in terms of hardware.

### INDUSTRIAL APPLICABILITY

The content receiver, the content reproducer, the management server, the content use system, the content use method, the method of write-out from the content receiver, the method of possible viewing time management on the content reproducer, the method of time limit fixation in the management server and other forms of the present invention have the effect of synchronizing expiration time limits for a content resulting from an export of the content for which only a viewable period is designated without setting any expiration time limit, are applicable to limited-time services in general and are also applicable to a form of service in which rentals content are sold by being written to removable media in shop terminals, a form of service in which rental contents are sold and distributed by being written to media in advance and other form of services as well as to the above-described services to distribute video and pieces of music through networks.

What is claimed is:

1. A content receiver which receives from a content server a content for which a possible viewing time is managed by a copyright protection system, and which writes out the content to a removable recording medium managed by a content protection system, the content receiver comprising:
a recording section which, when writing the content out to the removable recording medium, records, on the removable recording medium, together with the content, management server reference information indicating a location of a management server which fixes the possible viewing time in place of a unit for fixing the possible viewing time provided in the content protection system.

2. The content receiver according to claim 1, wherein
the management server reference information, is obtained by receiving a write-out license when the content is written out to the removable recording medium.

3. The content receiver according to claim 1, wherein
when writing the content out to the removable recording medium, if the possible viewing time is still unfixed, the recording section records information about the unfixed possible viewing time on the removable recording medium together with the content, or if the possible viewing time is already fixed, the recording section records the already fixed possible viewing time on the removable recording medium together with the content.

4. The content receiver according to claim 1, wherein
the management server reference information is a URL of the management server that fixes the possible viewing time for the content and that is managed by the copyright protection system.

5. A content reproducer which reproduces a content, a possible viewing time of which is managed by a copyright protection system, received from a content server and recorded on the removable recording medium managed by a content protection system, the content reproducer comprising:
a possible viewing time obtaining section which, at a time of fixing the possible viewing time for the content that has an unfixed possible viewing time, if management server reference information indicating a location of a management server which fixes the possible viewing time is recorded on the removable recording medium, makes a request of the management server indicated by the management server reference information to fix the possible viewing time for the content without using a unit for fixing the possible viewing time provided in the content protection system.

6. The content reproducer according to claim 5, wherein
if time limit synchronization management information for identifying the content as an object to be possible viewing time synchronized is recorded on the removable recording medium together with the content, the possible viewing time obtaining section transmits the time limit synchronization management information to the management server indicated by the management server reference information, when making the request to fix the possible viewing time.

7. A management server for managing a possible viewing time of a content for a content receiver which receives from a content server the content for which the possible viewing time is managed by a copyright protection system, and which writes out the content to a removable recording medium managed by a content protection system, and for a content reproducer which reproduces the content recorded on the removable recording medium, the management server comprising:
a possible viewing time supply section which, after receiving from the content reproducer a request to fix the possible viewing time,
(a) if the possible viewing time for the content is still unfixed, fixes the possible viewing time for the content with reference to a present time, records the fixed possible viewing time for the content, and supplies the content reproducer with the fixed possible viewing time as the possible viewing time for the content, and
(b) if the possible viewing time for the content is already fixed, supplies the content reproducer with the already fixed possible viewing time as the possible viewing time for the content,
wherein when the content receiver writes out the content to the removable recording medium, management server reference information indicating a location of the management server that fixes the possible viewing time is recorded on the removable recording medium together with the content, and
wherein if the management reference information is recorded on the removable recording medium when the content reproducer fixes the unfixed possible viewing time for the content, the request to fix the possible viewing time for the content is transmitted to the management server indicated by the management server reference information while a unit for fixing the possible viewing time provided in the content protection system is not used.

8. The management server according to claim 7, wherein
upon receiving a reproduction license request from the content receiver, if the content receiver has a function to reproduce the content,
(a) the possible viewing time supply section fixes the possible viewing time for the content with reference to the present time if the possible viewing time for the content is still unfixed, records the fixed possible viewing time for the content, and supplies the content receiver with the fixed possible viewing time as the possible viewing time for the content, and
(b) if the possible viewing time for the content is already fixed, the possible viewing time supply section supplies the content receiver with the already fixed possible viewing time as the possible viewing time for the content.

9. A content use system comprising a content receiver which receives from a content server a content for which a possible viewing time is managed by a copyright protection system, and which writes out the content to a removable recording medium managed by a content protection system, a content reproducer which reproduces the content recorded on the removable recording medium, and a management server which manages the possible viewing time for the content,
the content receiver having a recording section which, when writing out the content to the removable recording medium, records, on the removable recording medium, together with the content, management server reference information indicating a location of the management server that fixes the possible viewing time,
the content reproducer having a possible viewing time obtaining section which, at the time of fixing the possible viewing time for the content that has an unfixed possible viewing time, if the management server reference information is recorded on the removable recording medium, makes a request of the management server indicated by the management server reference information to fix the possible viewing time for the content without using a unit for fixing the possible viewing time provided in the content protection system,
the management server having a possible viewing time supply section which, after receiving from the content reproducer the request to fix the possible viewing time for the content,
(a) fixes the possible viewing time for the content with reference to a present time if the possible viewing time for the content is still unfixed, records the fixed possible viewing time for the content, and supplies the content reproducer with the fixed possible viewing time as the possible viewing time for the content, and
(b) if the possible viewing time for the content is already fixed, supplies the content reproducer with the already fixed possible viewing time as the possible viewing time for the content.

10. A content use method for a content use system including a content receiver which receives from a content server a content for which a possible viewing time is managed by a copyright protection system, and which writes out the content to a removable recording medium managed by a content protection system, a content reproducer which reproduces the content recorded on the removable recording medium, and a management server which manages the possible viewing time for the content, the content use method comprising:
a recording step of recording, on the removable recording medium, together with the content, management server reference information indicating a location of the management server that fixes the possible viewing time, when the content receiver writes out the content to the removable recording medium;
a possible viewing time obtaining step of obtaining the possible viewing time by making, at the time of fixing the possible viewing time for the content that has an unfixed possible viewing time, a request of the management server indicated by the management server reference information to fix the possible viewing time for the content without using a unit for fixing the possible viewing time provided in the content protection system, if the management server reference information is recorded on the removable recording medium; and
a possible viewing time supplying step of supplying the possible viewing time for the content after the management server has received the request to fix the possible viewing time for the content from the content reproducer, including:
(a) fixing the possible viewing time for the content with reference to a present time if the possible viewing time for the content is still unfixed, recording the fixed possible viewing time for the content, and supplying the content reproducer with the fixed possible viewing time as the possible viewing time for the content; and
(b) supplying, if the possible viewing time for the content is already fixed, the content reproducer with the already fixed possible viewing time as the possible viewing time for the content.

11. The content use method according to claim 10, wherein,
in the recording step, the management server reference information is obtained by receiving a write-out license from the management server when the content is written out to the removable recording medium;
the write-out license includes time limit synchronization management information for identifying the content as an object to be possible viewing time synchronized;
in the recording step, the time limit synchronization management information is also recorded when the content is recorded on the removable recording medium;
in the possible viewing time obtaining step, the time limit synchronization management information is transmitted to the management server when the request of the management server to fix the possible viewing time for the content is made; and
in the possible viewing time supplying step, it is determined whether the content requested to fix the possible viewing time is an object to be possible viewing time synchronized from the time limit synchronization management information received from the content receiver.

12. The content use method according to claim 10, further comprising:
a encrypting step of encrypting the content by means of the content receiver and encrypting a decryption key for decrypting the content by an encryption system in accordance with the copyright protection system; and
a decrypting step of decrypting by means of the content reproducer the content recorded on the removable recording medium,
wherein in the recording step, the encrypted content, the encrypted decryption key and the management server reference information are recorded on the removable recording medium, and
wherein in the decrypting step, a decryption key for decrypting the decryption key for the content is inquired and obtained from the management server indicated by the server reference information at the time of use of the content in the reproducer, the decryption key for the content is decrypted by using the obtained decryption key, and the content is decrypted by using the decrypted decryption key for the content.

13. The content use method according to claim 12, wherein
in the encrypting step, the decryption key for decrypting the content is generated by encrypting with values passed through a unidirectional function in the copyright protection system.

14. The content use method according to claim 12, wherein
in the decrypting step, when the decryption key for the content is decrypted, the decryption key for the content is decrypted using the decryption key obtained from the management server and a unique ID for the removable recording medium.

15. The content use method according to claim 12, wherein
in the possible viewing time obtaining step, the decryption key used for decrypting the decryption key for the content is supplied from the management server when the request to fix the possible viewing time for the content is made.

16. A method of write-out from a content receiver which receives from a content server a content for which a possible viewing time is managed by a copyright protection system, and which writes out the content to a removable recording medium managed by a content protection system, the method comprising:
a recording step of recording, on the removable recording medium, together with the content, management server reference information indicating a location of a management server which fixes the possible viewing time in place of a unit for fixing the possible viewing time provided in the content protection system, when the content is written out to the removable recording medium.

17. A method of possible viewing time management on a content reproducer which reproduces a content, a possible viewing time of which is managed by a copyright protection system, received from a content server and recorded on the removable recording medium managed by a content protection system, the method comprising:
a possible viewing time obtaining step of obtaining the possible viewing time by making a request of a management server indicated by management server reference information to fix the possible viewing time for the content without using a unit for fixing the possible viewing time provided in the content protection system, if the management server reference information indicating a location of the management server that fixes the possible viewing time is recorded on the removable recording medium at the time of fixing the possible viewing time for the content that has an unfixed possible viewing time.

18. A method of time limit fixation in a management server for managing a viewing time limit of a content for a content receiver which receives from a content server the content for which a possible viewing time is managed by a copyright protection system, and which writes out the content to a removable recording medium managed by a content protection system, and for a content reproducer which reproduces the content recorded on the removable recording medium, the method comprising:
a possible viewing time supplying step of supplying the possible viewing time for the content after a request to fix the possible viewing time has been received from the content reproducer, including:
(1) fixing the possible viewing time for the content with reference to a present time if the possible viewing time for the content is still unfixed, recording the fixed possible viewing time for the content, and supplying the content reproducer with the fixed possible viewing time as the possible viewing time for the content; and
(2) supplying, if the possible viewing time for the content is already fixed, the content reproducer with the already fixed possible viewing time as the possible viewing time for the content,
wherein when the content receiver writes out the content to the removable recording medium, management server reference information indicating a location of the management server that fixes the possible viewing time is recorded on the removable recording medium together with the content, and
wherein if the management reference information is recorded on the removable recording medium when the content reproducer fixes the unfixed possible viewing time for the content, the request to fix the possible viewing time for the content is transmitted to the management server indicated by the management server reference information while a unit for fixing the possible viewing time provided in the content protection system is not used.

19. A program embodied on a non-transitory and tangible computer-readable medium, the program causing a computer to execute a method of write-out from a content receiver'which receives from a content server a content for which a possible viewing time is managed by a copyright protection system, and which writes out the content to a removable recording medium managed by a content protection system, the method comprising a recording step of recording, on the removable recording medium, together with the content, management server reference information indicating a location of a management server which fixes the possible viewing time in place of a unit for fixing the possible viewing time provided in the content protection system, when the content is written out to the removable recording medium.

20. A program embodied on a non-transitory and tangible computer-readable medium, the program causing a computer to execute a method of possible viewing time management on a content reproducer which reproduces a content recorded on a removable recording medium, for which a possible viewing time is managed by a copyright protection system, which is received from a content server, and which is recorded on the removable recording medium managed by a content protection system, the method comprising a possible viewing time obtaining step of obtaining the possible viewing time by making a request of a management server indicated by management server reference information to fix the possible viewing time for the content without using a unit for fixing the possible viewing time provided in the content protection system, if the management server reference information indicating a location of the management server that fixes the possible viewing time is recorded on the removable recording medium at the time of fixing the possible viewing time for the content that has an unfixed possible viewing time.

21. A program embodied on a non-transitory and tangible computer-readable medium, the program causing a computer to execute a method of time limit fixation in a management server for managing a viewing time limit of a content for a content receiver which receives from a content server the content for which a possible viewing time is managed by a copyright protection system, and which writes out the content to a removable recording medium managed by a content protection system, and for a content reproducer which reproduces the content recorded on the removable recording medium, the method comprising:
a possible viewing time supplying step of supplying the possible viewing time for the content after a request to fix the possible viewing time has been received from the content reproducer, including:
(1) fixing the possible viewing time for the content with reference to a present time if the possible viewing time for the content is still unfixed, recording the fixed possible viewing time for the content, and supplying the content reproducer with the fixed possible viewing time as the possible viewing time for the content; and
(2) supplying, if the possible viewing time for the content is already fixed, the content reproducer with the already fixed possible viewing time as the possible viewing time for the content,
wherein when the content receiver writes out the content to the removable recording medium, management server reference information indicating a location of the management server that fixes the possible viewing time is recorded on the removable recording medium together with the content, and
wherein if the management reference information is recorded on the removable recording medium when the content reproducer fixes the unfixed possible viewing time for the content, the request to fix the possible viewing time for the content is transmitted to the management server indicated by the management server reference information while a unit for fixing the possible viewing time provided in the content protection system is not used.
